(19) United States
(12) Patent Application Publication
(10) Pub. No.: US 2005/0127172 A1
(43) Pub. Date: Jun. 16, 2005

(54) Access system

(76) Inventor: Robert J. Merkert SR., Voorhees, NJ (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/966,307

(22) Filed: Oct. 15, 2004

Related U.S. Application Data
(60) Provisional application No. 60/512,461, filed on Oct. 16, 2003.

(30) Foreign Application Priority Data
Jun. 16, 2003 (DE) DE 20309254.6

(51) Int. Cl. G06K 5/00

(52) U.S. Cl. 235/382

(57) ABSTRACT

An access system is disclosed that provides secured access to a security area. In some embodiments of the present invention, the access system includes an input device that is accessible to a user and capable of reading an authentication and/or identification information provided by the user; a standard signal control panel coupled to the input device for evaluation of the information provided by the user, the control panel being located in a secure area remote from the input device; and a signal processor coupled between the input device and the standard signal control panel, the signal processor being located in the secure area, wherein the input device provides data in a secured communication channel to the signal processor and the signal processor, in response to the data provided by the input device, provides the data to the standard signal control panel utilizing a standard signal. In some embodiments, the standard signal control panel may be a Wiegand or Magnetic-strip control panel. In some embodiments, the secured communications channel may be an RS422, RS485 or a TCP/IP protocol channel.

### RELATED APPLICATIONS

This application claims priority to U.S. Provisional Application No. 60/512,461 filed Oct. 16, 2003, entitled “Access System” and U.S. application Ser. No. 10/870,475 filed Jun. 16, 2004, entitled “Access System,” which claims priority to Germany Application DE 20309254.6, filed on Jun. 16, 2003 in Germany, all of which are herein incorporated by reference in their entirety.

### FIELD OF THE INVENTION

The present invention is related to access devices to provide physical access to a secured area and, in particular, to access devices compatible with current access control systems while providing higher levels of security.

### BACKGROUND OF THE INVENTION

Secured access to sensitive areas has become an important issue, especially after the events of Sep. 11, 2001. As such, there is a current focus on technological systems for controlling access to security areas in both the private and public arenas. Such systems must be made highly impervious to attack by those wishing to gain unauthorized access to the secured area.

Security systems using, for example, Wiegand readers and control panels adapted to evaluate the data read from a Wiegand card are well known and widely employed in various applications like systems for unlocking doors or parking garage gates, etc. Usually, the Wiegand reader is located to be accessible to the user (Wiegand card holder) while the control panel, which after a positive evaluation of the data, performs a security relevant operation (e.g. unlocking a door) is located in an area which is not accessible to the user, e.g. in a secure room, to guarantee a certain level of security.

U.S. Pat. No. 5,679,945 discloses an access system that provides an “intelligent” card reader in order to replace existing magnetic stripe readers, bar code readers and Wiegand readers without the need for retrofitting of existing computer systems, which are coupled to the existing readers. However, readers that utilize a standard signal for communication into a secured area are easily attacked by those seeking unauthorized access to the secured area. Therefore, access systems utilizing readers that provide standard signals (e.g., Wiegand, Mag Stripe, or bar-code standard signals) do not provide a high level of security because those signals are more susceptible to, for example, replay attacks. Replay attacks in a conventional access control system can be accomplished by an intruder gaining access to the communication wires. By capturing the data sent on a valid data transfer, the attacker can later replay the same data and gain unauthorized entrance.

Therefore, there is a strong need, especially in a highly security conscious environment, to provide access systems with high levels of security against unauthorized access.

### SUMMARY

In accordance with the present invention, an access system is provided that includes an input device accessible to a user and capable of reading authentication and/or identification information provided by the user, and a standard control panel coupled to the input device for evaluation of the information provided by the user. The standard control panel can be located in a secure area remote from the input device and can accept input signals compatible with those from standard signal readers that read traditional access cards, such as, for example, magnetic strip (Mag Stripe) cards, Wiegand cards, bar-code cards, etc. The input device can, for example, be a device that reads smart cards or memory cards, either contact or contactless. In some embodiments, the input device can also read inputted information from the user (user information) or data regarding the user (e.g., biometric data such as fingerprints).

An access system according to the present invention can include an input device that is accessible to a user and capable of reading authentication and/or identification information provided by the user; a standard signal control panel coupled to the input device for evaluation of the information provided by the user, the control panel being located in a secure area remote from the input device; and a signal processor coupled between the input device and the standard signal control panel, the signal processor being located in the secure area, wherein the input device provides data in a secured communication channel to the signal processor; and the signal processor, in response to the data provided by the input device, provides the data to the standard signal control panel utilizing a standard signal.

These and other embodiments are further discussed below with respect to the following figures.

### BRIEF DESCRIPTION OF THE DRAWINGS

FIG. 1 shows a block diagram illustrating an access system according to the prior art.

FIG. 2 shows a block diagram of an embodiment of an access system according to the present invention.

FIG. 3 is shows a block diagram of embodiment of an access system according to the present invention.

FIG. 4 shows a block diagram of an embodiment of an access system according to the present invention.

FIG. 5 shows a block diagram of an embodiment of an access system according to the present invention that utilizes encrypted or signed, self-clocked data transmission.

FIGS. 6A and 6B illustrate uni-directional and bi-directional data transmission, respectively.

FIG. 7 illustrates sample wave shapes for Wiegand signals, Mag-Stripe signals, and self-clocked di-phase signals.

FIG. 8 illustrates sample timing diagrams for self-clocked di-phase communication on Transmit and Receive data.

FIG. 9 shows a block diagram of a signal processor according to the present invention.

FIG. 10 shows a security system according to the present invention.

FIG. 11 illustrates relative security level based on combinations of various inputs requested of a user attempting to gain access.

FIG. 12 illustrates a three-factor card reader.

FIG. 13 illustrates other card readers.

In the figures, elements having the same designation have the same or similar functions.

### DESCRIPTION OF THE EMBODIMENTS

Embodiments of the present invention provide an access system with an extremely high level of security. Embodiments of the invention include a signal processor coupled between the input device and the control device. The input devices in some embodiments can include encryption to encrypt information obtained from the user (i.e., from a memory or smart card, from input to a keypad, and/or from user data—for example fingerprints). The signal processor, which can be placed in a secured location, can convert the encrypted information into a standard signal that can be sent to the standard control device, for example a standard Wiegand signal, magnetic strip signal, or strip-chart signal. Embodiments of the present invention, then, can be highly versatile because they can, for example, be utilized with Wiegand control panels without being restricted to Wiegand readers as input devices and without transmitting insecure Wiegand signals from the reader to a secured area.

With the signal processor located in a secured location, for example at or near the control panel, the risk of interference with the data by those attempting to gain unauthorized access can be significantly reduced. A higher level of security can be guaranteed with regard to the data transfer from the input device to the control panel because it is not possible to intercept and abuse the authentication/identification information provided by the user if it is encrypted until it reaches the signal processor, especially if the signal processor and the control panel are located in a secure area which is not accessible from an unsecured area, and if a dynamic element is used in the data transfer. A second communication channel between the input device and the securely located signal processor can be provided. The input device can include a smart card reader into which a secure output can be implemented, for example an RS422, an RS485 or a TCP/IP output protocol can be implemented in some embodiments.

An access system according to some embodiments of the present invention may further include a host computer coupled to the input device and located remotely from the input device. The host computer may also be coupled to the control panel and the signal processor. Data may be transmitted between the input device and the host computer utilizing, for example, an RS485 or a TCP/IP protocol

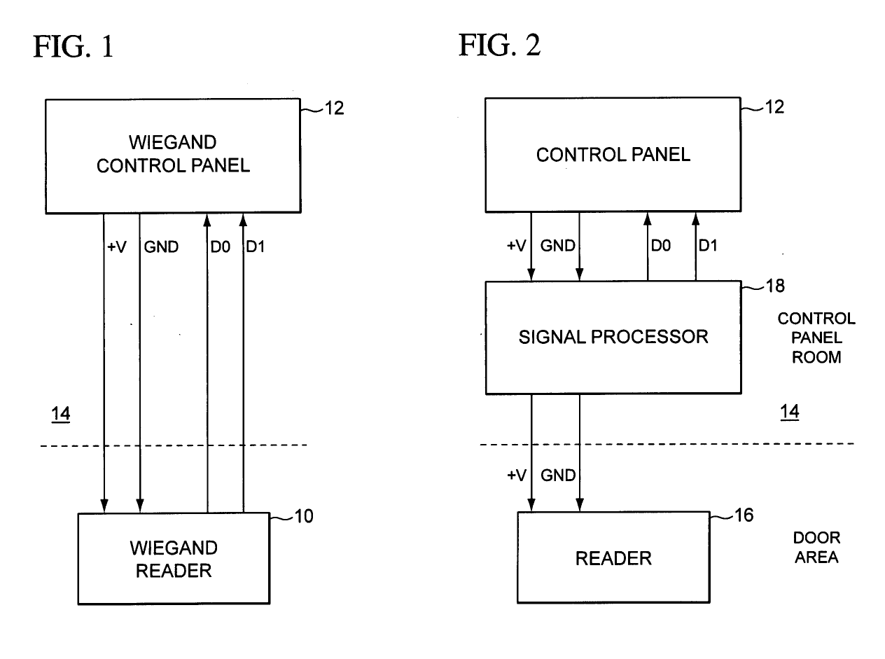

FIG. 1 shows a block diagram of a prior art access system that includes a standard Wiegand reader 10 and a Wiegand control panel 12 adapted to retrieve data from standard Wiegand reader 10. The Control panel 12 is located in a secure area 14 remote from Wiegand reader 10, which is accessible to a user attempting to obtain access to a secure area. In order to gain access, the user inserts his Wiegand card (not shown), which contains authentication and, if required, identification information, into the Wiegand reader 10. The information is transmitted from the reader 10 to the control panel 12 where the information is evaluated. Depending on the result of the evaluation, the control panel 12 either performs a security relevant operation, e.g. unlocking a door or the like, to grant the user the requested access, or it denies access.

The weak point in an access system such as that illustrated in FIG. 1 is the link between Wiegand reader 10 and control panel 12. The Wiegand data lines are susceptible to replay attacks, i.e. data can be intercepted at the wiring going into secured area 14 and replayed to gain unauthorized entrance.

FIG. 2 shows an embodiment of an access system according to the present invention. A reader 16 is coupled to a signal processor 18. Signal processor 18 receives signals from reader 18 and converts these signals to standard signals that can be transmitted to control panel 12. In some embodiments, signal processor 18 and control panel 12 are physically located in a secured area 14. In some embodiments, control panel 12 can be a Wiegand control panel. It should be understood that the term “Wiegand control panel” is not restricted to a particular hardware configuration but rather includes any suitable control panel, which is capable of processing data signals in a Wiegand format by using corresponding signal processing or software. Additionally, although an embodiment utilizing a Wiegand control signal is described here, other control signal formats can also be utilized, for example magnetic strip (Mag Stripe) formats or bar-code formats.

In the embodiment shown in FIG. 2, the standard Wiegand reader 10 shown in FIG. 1 is replaced by another input device, for example a smart card reader 16 into which a smart card (not shown) containing authentication/identification information can be inserted (for contact reading) or otherwise interfaced with (for example for contactless reading). Reader 16 can include an encryption circuit that encrypts the information read from the smart card and an output port, for example an RS422, an RS485 or a TCP/IP output port, for outputting data to signal processor 18. The embodiment of the access system shown in FIG. 2 includes a signal processor 18 coupled between reader 16 and control panel 12. Signal processor 18 and control panel 12 can be co-located in secure area 14, which is remote from card reader 16.

In some embodiments, card reader 16 can include a contactless reader for reading a contactless smart card. In general, embodiments of card reader 16 can include contactless smart card readers, contact smart card readers, memory card readers, a user input device such as a keypad on which a user can input authentication/identification data, biometric devices such as a fingerprint or retinal scan reader for directly evaluating the identity of the user, and other signaling devices for communicating with the user.

To begin operation of the embodiment of the access system shown in FIG. 2, the user inserts a smart card into smart card reader 16, or in the case of a contactless smart card brings the smart card in close proximity to reader 16. The information on the smart card is read by reader 16. In some embodiments, the information from the smart card can be encrypted in reader 16. The information can then be transmitted to signal processor 18 using a secured, for example RS422, RS485 or TCP/IP protocol, output port. Data transfer between smart card reader 16 and signal processor 18, then, can be regarded as a “secure channel.” Signal processor 18 converts the information received from reader 16 into a standard signal (e.g., a Wiegand signal, a bar code signal, or a magnetic stripe signal) that can be received by control panel 12. Control panel 12 is able to evaluate the standard signal and, based on access protocols, decides whether to allow or to deny access to the user.

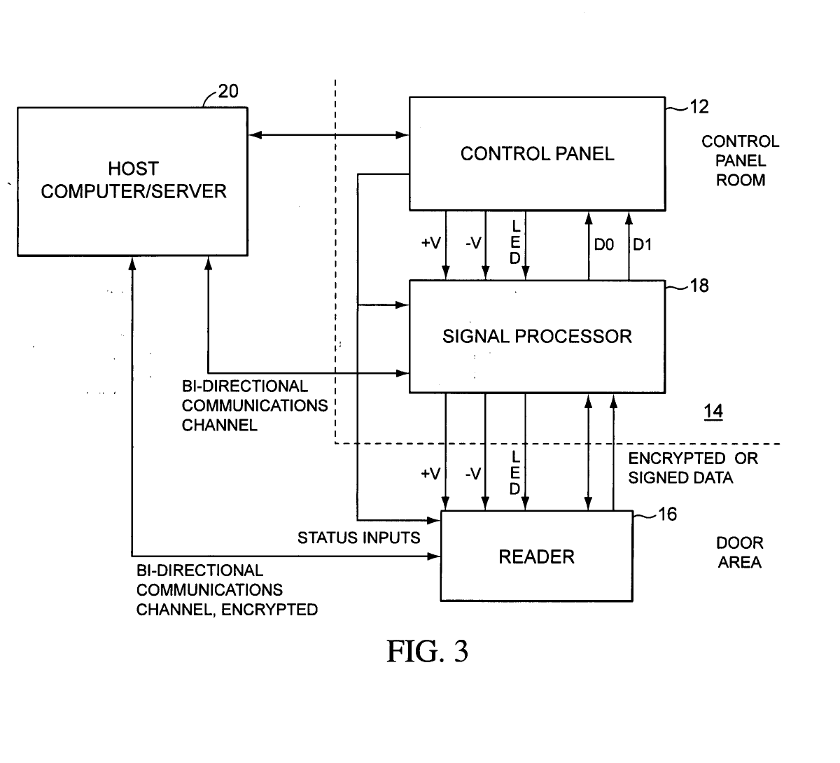

FIG. 3 shows another embodiment of access system according to the present invention. The embodiment shown in FIG. 3 includes reader 16, signal processor 18 and control panel 12 as was previously discussed with FIG. 2. Further, a host computer 20 can be coupled to one or more of control panel 12, signal processor 18, and reader 16. Remote host computer 20 can be located outside secure area 14 and is coupled to reader 16 and to control panel 12. Communication between host computer 20 and reader 16 can be provided by a further secure channel, for example data can be transferred using an RS485 or a TCP/IP protocol.

The operation of the embodiment of the access system of FIG. 3 to gain access is similar to that described above with respect to FIG. 2. However, the embodiment of access system shown in FIG. 3 can easily be adapted to various requirements. For example, the secure channel between remote host computer 20 and reader 16 can be used to change the configuration of reader 16 on command from host computer 20 in a comfortable and secure manner. For example, differing levels of security can be implemented by sending commands to reader 16 and control panel 12 from host computer 20. Additionally, host computer 20 can be used to define the type of input devices from which correct identification data is obtained that are required to gain access. Suitable input devices that can be included in reader 16 include a contactless smart card reader, a contact smart card reader, PIN pads (or keypads), biometric devices (for example fingerprint or retinal readers), and combinations thereof. The input devices from which data is required in order to gain access can be changed as a function of security threat level, day of week, time of day, or other conditions. The coupling between host computer 20 and control panel 12 allows checking as to whether a control panel operation has been successfully executed. Further, host computer 20 can be used to identify a possible malfunction of control panel 12 by utilizing test signals.

Additionally, reader 16 may include user-interface (for example a data screen or set of LED displays) for communicating information to a user. The LED signals may originate from control panel 12 and be transmitted through the secured channel between signal processor 18 and reader 16 as is indicated in FIG. 3. Further, the secured channel between signal processor 18 and reader 16 may be bi-directional as is shown in FIG. 3. In that case, control panel 12 may transmit data and instructions to reader 16, for example regarding security levels and such, over a bi-directional secured line. Additionally, LED display data may be transmitted between control panel 12 and reader 16 over separate lines or through the bi-direction secured line. Control panel 12 may also communicate system status to reader 16 for display to a user directly without communicating through signal processor 18.

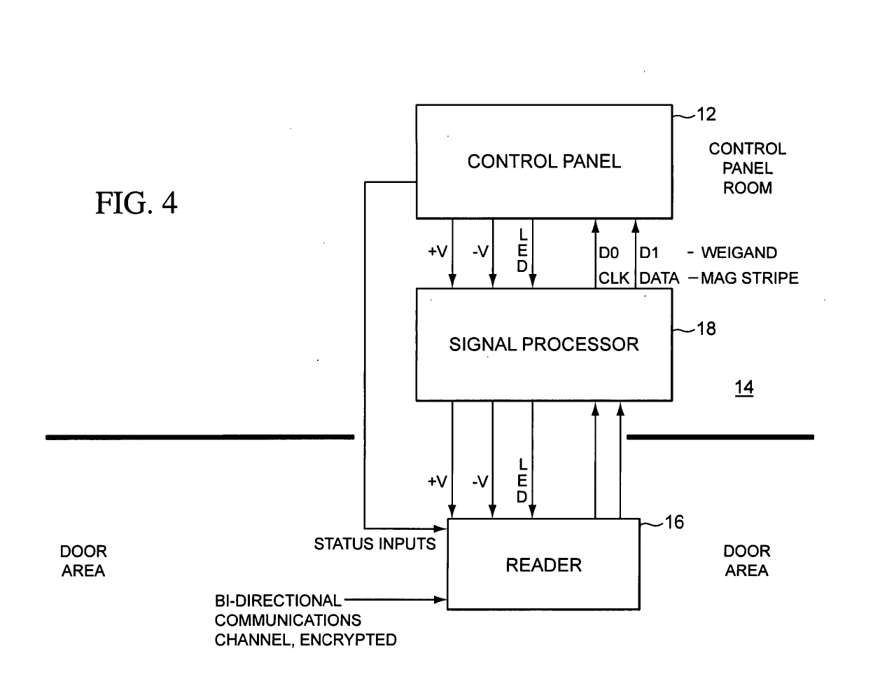

FIG. 4 illustrates an access system similar to that illustrated in FIG. 3, except that the secured channel between reader 16 and signal processor 18 is a unidirectional line. Reader 16, then, cannot receive data from control panel 12 through the secured channel. In some embodiments, status information can be communicated between control panel 12 and reader 16 using a separate line. Status information can be displayed in reader 16 through LCD displays, LED lights, or audible tones, for example. As further shown in FIG. 4, setup information can be transmitted to reader 16 separately. Setup information can include for example, which of the various input devices of reader 16 are activated in order to collect the appropriate information from the user to meet the current level of security.

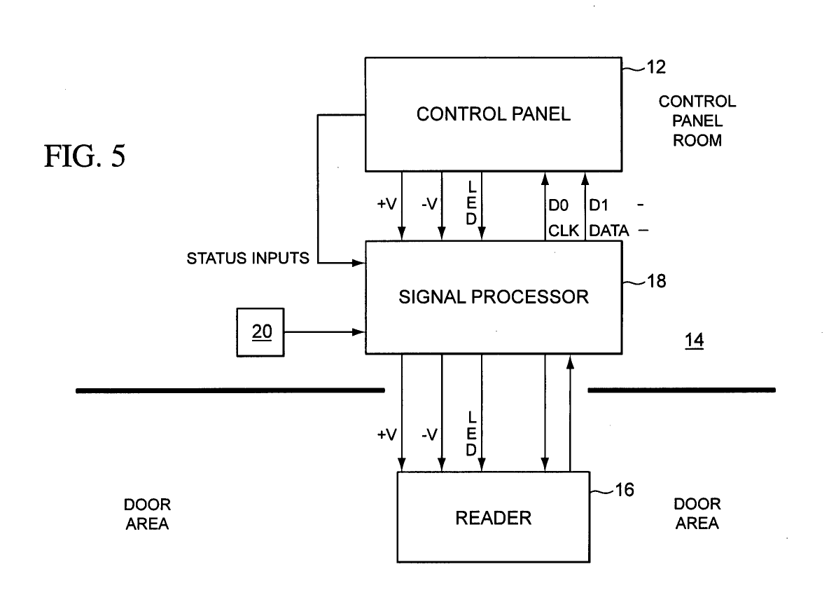

FIG. 5 illustrates another embodiment of an access system according to the present invention. As has been discussed above, reader 16 is typically located in a non-secure area on the outside of a locked entranceway. Reader 16 can include interfaces for smart cards, contactless smart cards, biometric readers (e.g. fingerprint readers), PIN pads, and/or other user interface devices. Reader 16 transmits data which may be encrypted and/or digitally signed, extracted from a smart card or other input device to signal processor 18, which is located in secure area 14. In some embodiments, signal processor 18 can be located near or possibly in standard signal control panel 12.

Digital signatures may be used to authenticate the information being sent to the control panel to ensure that it originated with the card or device that actually sent the information, and to ensure that the transmitted information was not altered after the information being transmitted was digitally signed.

There exist many well-known processes for creating and validating digital signatures. One example is the Digital Signature Algorithm, which may be used by a signatory to generate a digital signature on data and by a verifier to verify the authenticity of the signature. Each signatory has a public and private key. The private key is used in the signature generation process and the public key is used in the signature verification process.

To generate the correct digital signature for a signatory, knowledge of the private key of the signatory is needed. In other words, signatures cannot be forged, without knowledge of a signatory's private key. However, by using the signatory's public key, anyone can verify a correctly signed message.

The Digital Signature Algorithm uses parameters denoted by p, q, g, and x, which are defined below:

p is an L-bit prime p, where 512≦L≧1024, and L is divisible by 64;

q is a 160-bit prime q, such that q is a factor of p−1, i.e. (p−1)=qz, where z is any natural number;

h is chosen such that, 1<h<p−1 and g=h^{z} mod>1;

x is chosen randomly such that 0<x<q and y=g^{x} mod p.

The Public Key is y and the Private Key is x.

To generate a digital signature, the algorithm also makes use of a one-way hash function, SHA(m), such as, for example, the Secure Hash Algorithm, and a randomly generated number k, where 0<k<q. Parameter k is regenerated for each time a signature is generated. Parameters x and k are used for signature generation and are kept secret.

The Digital Signature (r,s) of a message M is the pair of numbers r and s computed according to the equations below:
r=(g^{k} mod p) mod q and
s=(k⁻¹ SHA(M)+xr)) mod q.

Prior to verifying the signature in a signed message, p, q, g and the sender's public key y and identity are made available to verifiers. These parameters may be publicly distributed. Additionally, the Digital Signature (r, s) is also made available along with its associated message M to potential verifiers.

To verify the signature, the verifier first checks to see that 0<r<q and 0<s<q; if either condition is violated, the signature is invalid.

If these two conditions are satisfied, the verifier computes:
w=s⁻¹ mod q;
u₁=((SHA(M))*w)mod q;
u₂=(rw) mod q; and
v=((g^{u1}*y^{u2}) mod p) mod q.

If v=r, then the signature is verified. On the other hand, if v≠r, then the message may have been modified and the signature should be considered invalid.

In some embodiments, data sent from reader 16 to signal processor 18 can be clocked data or self-clocked data. As has been described above, signal processor 18 converts the data received from reader 16 into a standard format signal, such as, for example, Wiegand, Mag Stripe, or bar code that is recognizable by standard signal control panel 12.

In some embodiments, a host computer 20 can communicate with signal processor 18 and with reader 16 through signal processor 18. As discussed above, host computer 20 can, for example, vary the level of security or alter the action or display setup of reader 16.

In some embodiments, a security module or processor is located in each of reader 16 and signal processor 18 to allow for the secure transfer of data between reader 16 and signal processor 18, either through encryption or digitally signing the data. In some embodiments, a dynamic element can be used in the data transmission process to ensure that a replay attack cannot be used to gain unauthorized access to an entrance portal through reader 16. Replay attacks in a conventional access control system can be accomplished by an intruder gaining access to the communication wires, between the output terminal of reader 10 (FIG. 1) and the control panel 12. By capturing the data sent on a valid data transfer, the attacker can later replay the same data and gain unauthorized entrance. In some embodiments consistent with the present invention, the dynamic element could include date and time information corresponding to the date and time when the reader was accessed. The date and time information can be sent to the signal processor, which can then check the received information with the current date and time to ensure that the information sent is not a replay attack.

In some embodiments, the secured communication channel between reader 16 and signal processor 18 can utilize the wiring that may be in place when replacing a conventional access system, for example the Wiegand wiring. The existing two wires can be used for data and clock for one-way communication between reader 16 and signal processor 18 or bi-directional communication can be established using self-clocked data, for example non-return to zero (NRZ) or Di-phase communications. There are many advantages to using a bi-directional communication path between reader 16 and signal processor 18. Some of these include error retransmission capability, the ability to transmit status level information between control panel 12 to reader 16 via data signal processor 18, and general two-way communications for various other functions.

Utilizing self-clocked NRZ or Di-phase communication between reader 16 and signal processor 18 allows for improved data detection and immunity to sporadic ‘noise’ signals generated by external sources on the data lines between reader 16 and signal processor 18. The technique employs the use of a sampling clock that is at a frequency of 8, 16, 32 or higher times that of the data transmission frequency. Multiple samples can be taken of the data line in each bit transmission in order to ascertain the data bit's true state. A plurality of clock signals indicating the same data status during the given bit time can be used to ascertain the state of the data bit. In some embodiments, both reader 16 and signal processor 18 can have independent sampling clocks running at the same higher frequency as that of the data bit frequency. In some embodiments, the data between reader 16 and signal processor 18 may be out of synchronization by only a few, for example one, clock cycle of the higher frequency clock.

Di-phase communication can be used to further improve communication between reader 16 and signal processor 18. The state of the data is changed on every data bit time period. If the data were in a high state it would be changed to a low state, and vice versa. A data ‘one’ is in the same state for the entire bit period. A data ‘zero’ changes state at the half-bit time. The value of the data bit is determined by comparing the state of the data bit during the first half of the data bit period and the second half of the data bit period. If the data state is the same in both half-bit times, the value of the data bit is a ‘one’; if the data state is different in both halves of the bit time the data bit is a ‘zero’.

In some embodiments, reader 16 can change configuration on request from a host computer via a communications channel or from control panel 12 through status lines. In some embodiments, data signal processor 18 can receive configuration information from host computer 20 or from standard signal control panel 12 and can transmit the configuration data to reader 16 via the bi-directional data lines between signal processor 18 and reader 16. An example of configuration information being sent to reader 16 is a requirement for additional user inputs, such as card and PIN pad data; card, PIN pad and biometric data; or other combinations. Such security level changes may be sent as required based on time of day, day of the month, or National Security levels.

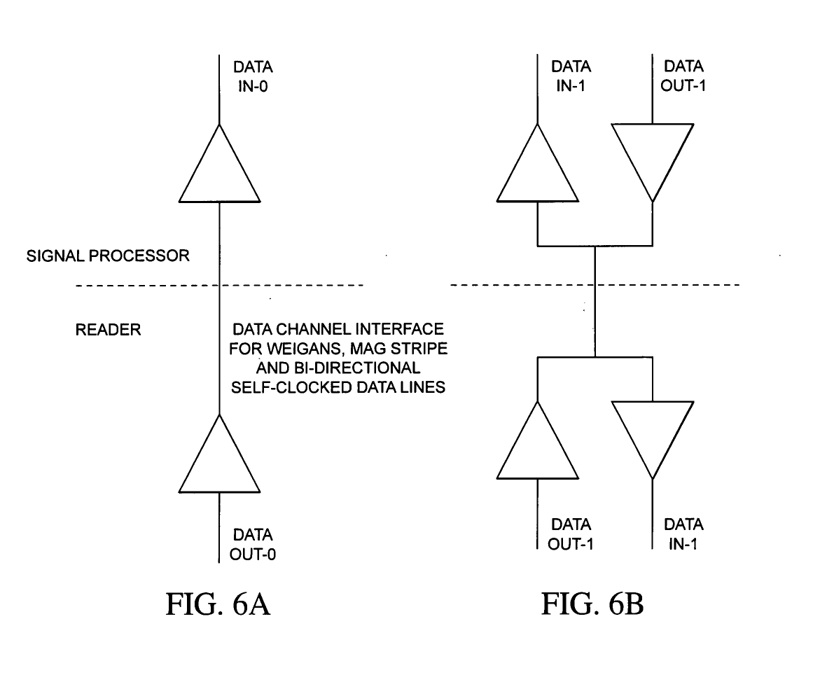

FIGS. 6A and 6B illustrate uni-directional and self-clocked bi-directional data lines, respectively. FIG. 6A shows how the Data out-0 line from the reader, such as from exemplary reader 16, is sent to the Signal Processor across the data channel interface. A signal arriving on the Data out-0 or D0 lines, at the Signal Processor is always interpreted as a “0”. FIG. 6B shows transmission of data using a self-clocked bi-directional line for the Data in-1 signal, across the data channel interface. Data transmitted by the Reader is buffered and sent to the Signal Processor. Similarly, data transmitted by the Signal Processor is buffered and sent to the Reader. A signal arriving on the Data out-1, Data in-1 or D1 line at the Signal Processor is always interpreted as a “1”.

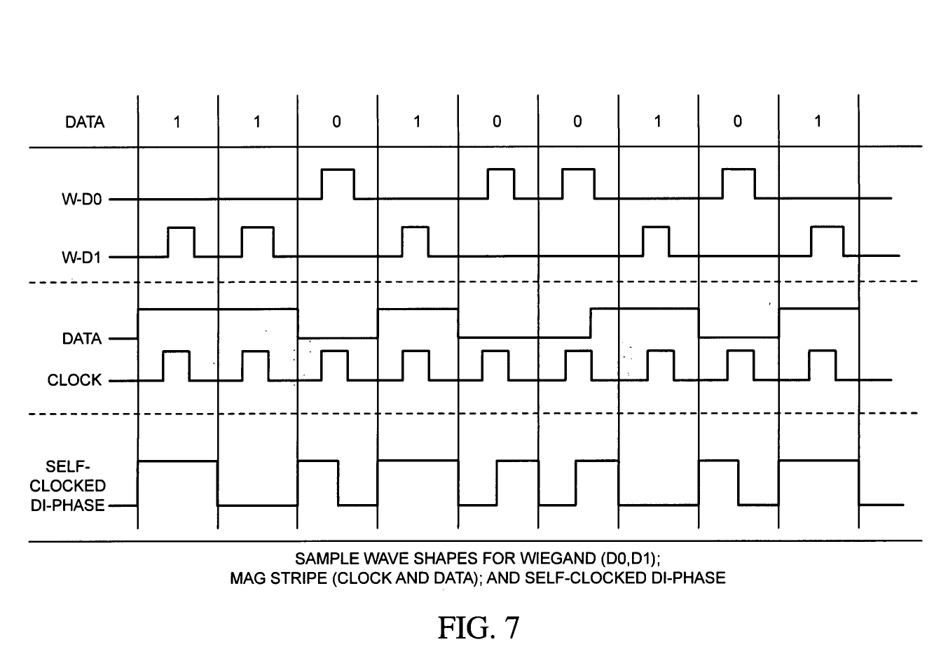

FIG. 7 illustrates sample wave shapes for Wiegand (D0, D1), Mag Stripe (Clock and Data), and self-clocked Di-phase. The data being transmitted, shown in the Data row of FIG. 7 is the 9-bit binary stream “110100101”. As shown in FIG. 7, transmission of this data using Wiegand (D0, D1) depicted as W-D0 and W-D1 uses 9 clock cycles. Whenever a “0” is being transmitted during a clock cycle, the W-D0 line is asserted. If a “1” is being transmitted during a clock cycle, the W-D1 line is asserted. Thus, the W-D1 line is asserted during the first two clock cycles corresponding to the first two binary digits “11” of the 9-bit stream being transmitted. On the third clock cycle, the W-D0 line is asserted corresponding to the third digit (“0”) of the binary stream. In the Mag Stripe (Clock and Data), as shown in FIG. 7, the Data line is asserted for “1's” and negated for “0's”. Thus, the Data line is asserted for the first two clock cycles and then negated during the third clock cycle corresponding to the initial “110” data sequence of the 9-bit stream.

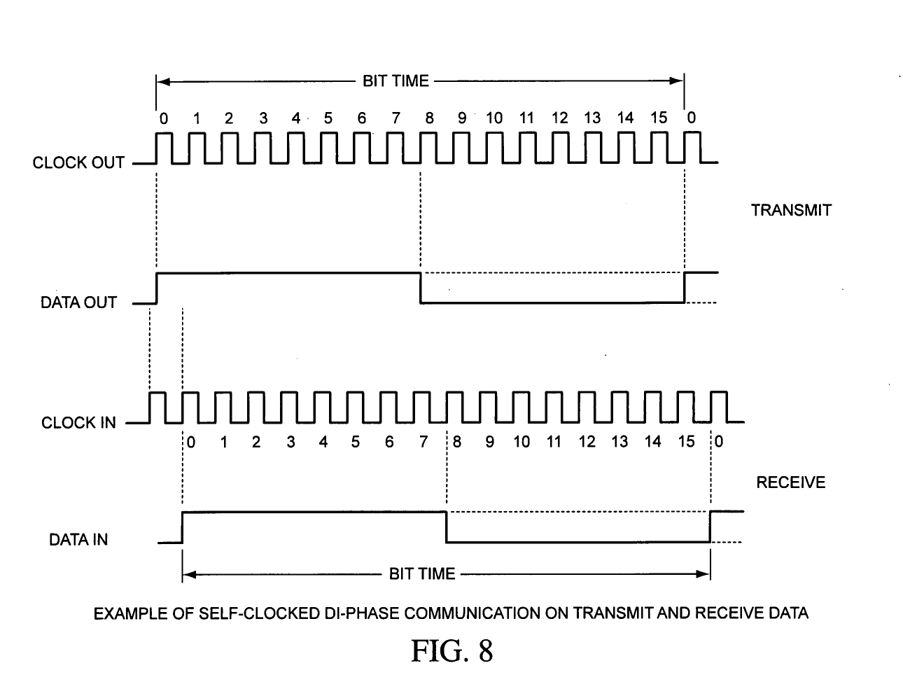

In the Self-Clocked Di-phase scheme, if the line is held to a constant value over the entire clock period, then the data being transmitted is a “1”. On the other hand, if the line value changes in the middle of the clock period the data being transmitted is a “0”. Thus, the line is high for the entire first clock period, low for all of the second clock period, and changes in the middle of third clock period corresponding to the “110” data sequence. FIG. 8 illustrates an example of self-clocked Di-phase communication, on transmit and receive data. FIG. 8 shows changes in the “Data Out” and “Data In” signals over 16 cycles of the base input clock, which corresponds to the Bit Time or Bit Period. Changes in Data Out or Data In during the bit period indicate that a “0” is being transmitted whereas a constant value (0 or 1) for the entire period indicates that the data on the line is a “1”.

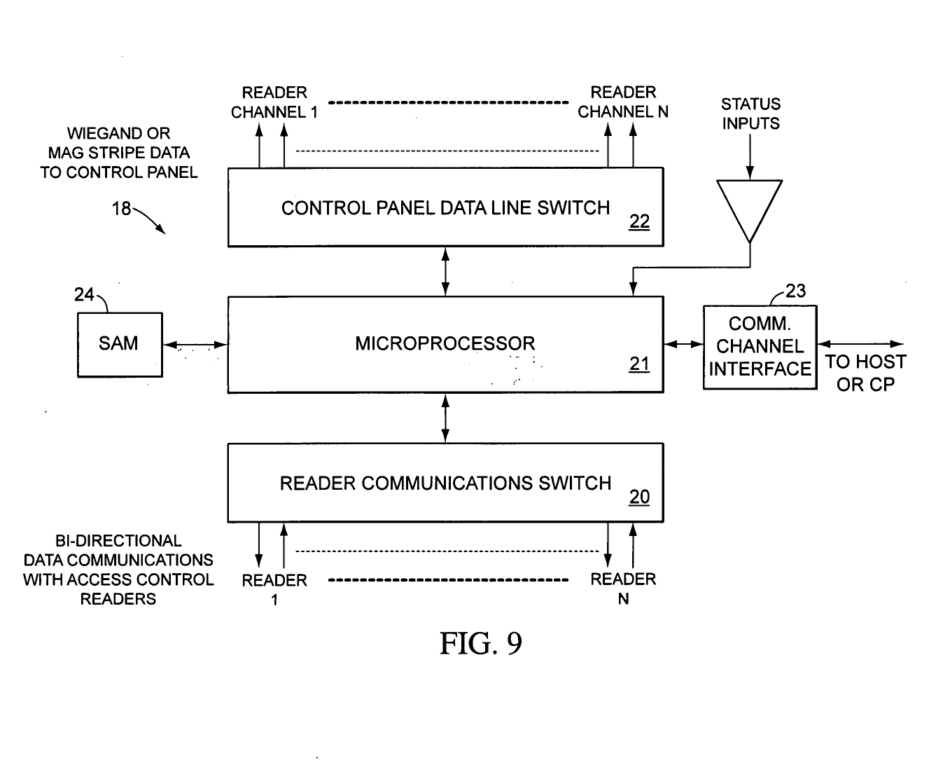

FIG. 9 shows an embodiment of signal processor 18. The embodiment of signal processor 18 shown in FIG. 9 includes a microprocessor 21 coupled to a reader communications switch 20 and a control panel data line switch 22. Further, microprocessor 21 may be coupled to a communications channel interface 23 for communications with host computer 20 and to a security access module (SAM) 24.

Reader communications switch 20 can be coupled to one or more readers 16 of differing types through, for example, a bidirectional data communications channel. Further, data regarding each of the readers can be communicated to control panel 12 through control panel line switch 22. In some embodiments, data regarding the readers could include data regarding the status of the readers, such as whether they are active, inactive or malfunctioning.

Conversion of data from reader 16 to a standard signal for standard signal control panel 12 can be accomplished in software operating on microprocessor 21 and stored in memory. In some embodiments, software operating on microprocessor 21 and stored in memory could implement portions of a digital signature verification and authentication algorithm. SAM 24 stores and implements encryption codes and, in some embodiments, can be removable using a “SAM lock”.

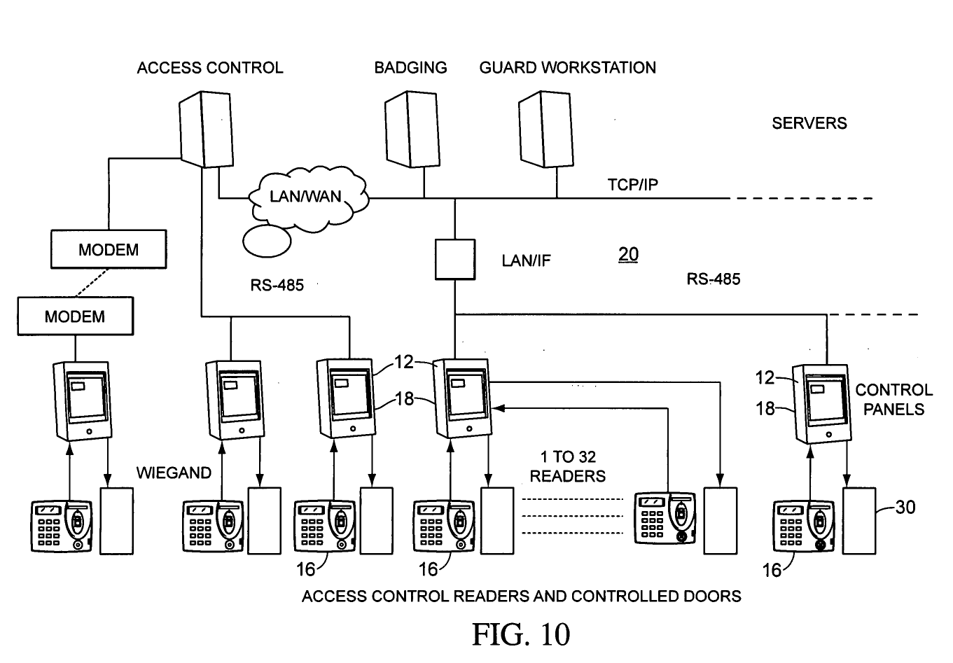

FIG. 10 shows an example of a security system according to the present invention. A security system according to the present invention includes one or more access systems according to the present invention. Further, host computer 20 may include one or more workstations, such as an access control station, badging station, and guard workstation. As shown, control panel 12 communicates, through signal processor 18, with reader 16 and can open an appropriate door 30 once access is approved.

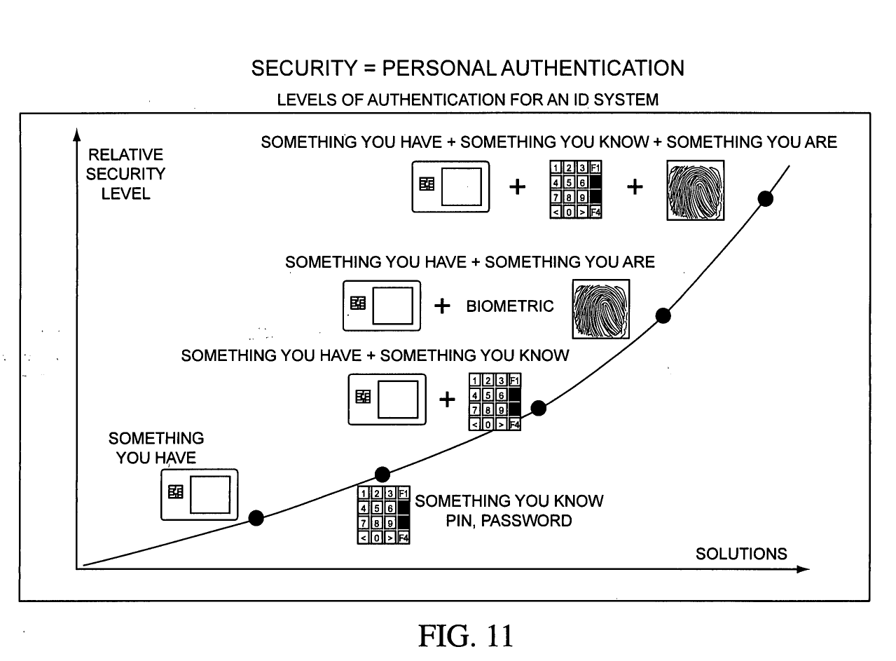

In some embodiments of the invention, various levels of security may be programmed into control panel 12 and reader 16. For example, security levels may be classified with regard to threat level, for example low, guarded, significant, high, and severe. The level of authentication/identification required for each threat level may be different. For example, in a low threat security environment access may be gained with a contactless card. With a guarded level, the access system may be set to require both a contactless card and that the user input a personal identification number (PIN) into a keypad. With a significant threat, a contact card and a PIN may be required. In a high threat security level, a contact card and some biometric input (e.g., fingerprint) may be required to gain access. In a severe threat security level, three inputs—a contact card, a PIN, and a biometric input—may be requested of a user attempting to gain access. FIG. 11 illustrates the relative security level with respect to various inputs and combinations of inputs requested of the user in a security system. In some embodiments, a single smart card may be configured to provide both contactless and contact connection with reader 16.

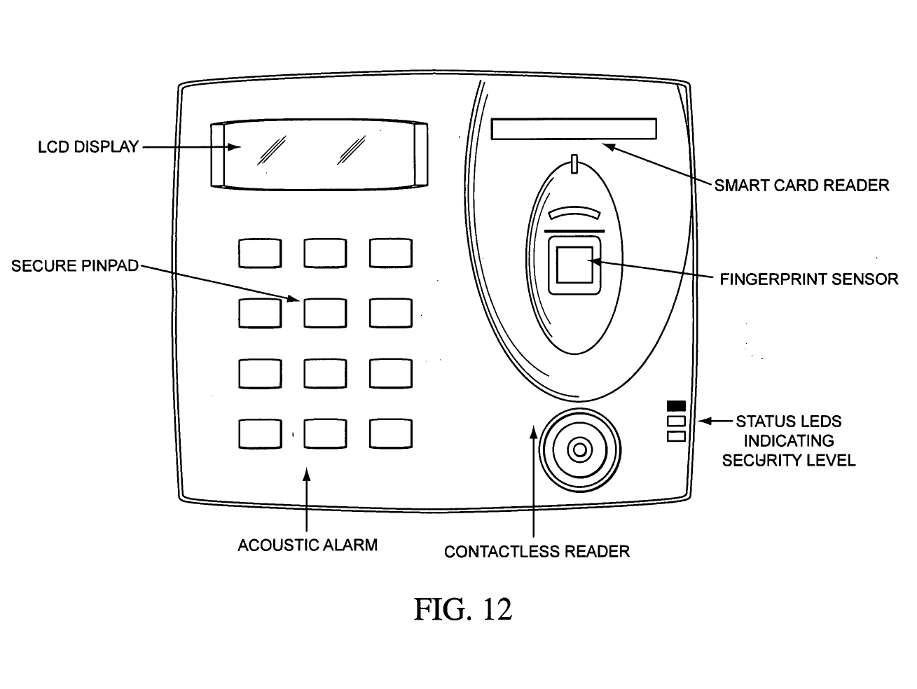

FIG. 12 illustrates a card reader that can be utilized in embodiments of the present invention. The embodiment of card reader shown in FIG. 12 includes an LCD display, a keypad for accepting PIN information, a smart card reader, a contactless reader, and a fingerprint sensor. A series of LEDs can indicate security level. Further, an acoustic alarm may be included.

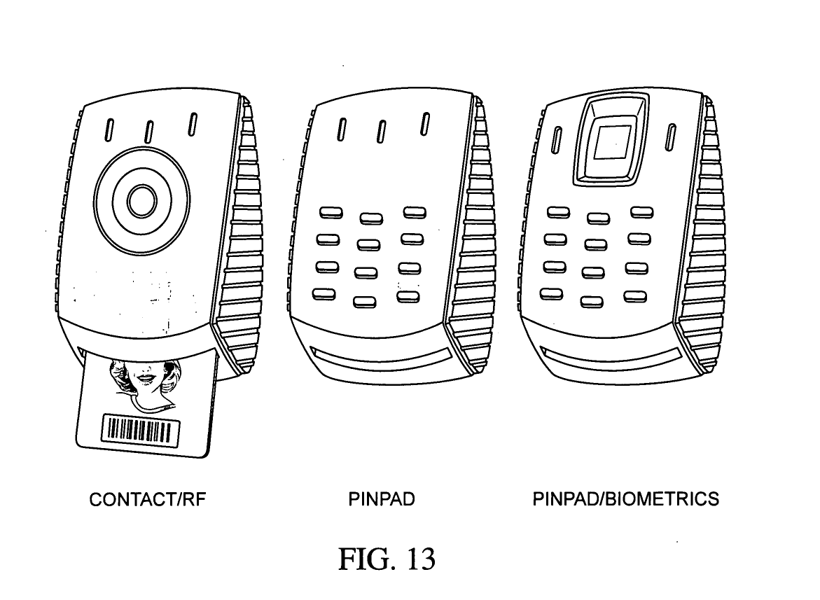

FIG. 13 illustrates other types of card readers that may be utilized with embodiments of the present invention.

Although any standard formats may be utilized in embodiments of the present invention, in some embodiments, the contact card readers may be ISO 7816 card readers and the contactless cards may be ISO 14443, parts 1-4 with a FIPS 140-2 approved algorithm. Further, the card reader can be programmable, for example in order to extract SEIWG-12 data strings or other ID strings from a smart card.

Several standards and working groups have been established in the area of access control. For example, the Security Equipment Integration Working Group has issued a specification on Sep. 30, 2002: “Development of a specification for SEIWG-compliant Access Control Components; a study by the Security Equipment Integration Working Group,” Sep. 30, 2002, which is herein incorporated by reference in its entirety and made a part of this disclosure. Further, the Physical Access Interoperability Working Group has implemented a “Technical Implementation Guidance: Smart Card Enabled Physical Access Control Systems, Version 1.0,” Jul. 2, 2003, which is herein incorporated by reference in its entirety and made a part of this disclosure. Additionally, the Security Industry Association has issued an “Access Control Standard Protocol for the 26-Bit Wiegand Reader Interfaces,” Oct. 17, 1996, which is herein incorporated by reference in its entirety and made a part of this disclosure. The later document provides information regarding the Wiegand standard.

Other embodiments of the invention will be apparent to those skilled in the art from consideration of the specification and practice of the invention disclosed herein. For example, embodiments utilizing standards other than the Wiegand standard for signaling between signal processor 18 and control panel 12 can be utilized. Additionally, other protocols may be utilized for secure transmission channels other than the RS422, RS485 or TCP/IP protocols described as examples here. It is intended that the specification and examples be considered as exemplary only, with a true scope and spirit of the invention being indicated by the following claims.

1. An access system, comprising:
an input device that is accessible to a user and capable of reading authentication and/or identification information provided by the user;
a standard signal control panel coupled to the input device for evaluation of the information provided by the user, the control panel being located in a secure area remote from the input device; and
a signal processor coupled between the input device and the standard signal control panel, the signal processor being located in the secure area,
wherein the input device provides data in a secured communication channel to the signal processor and the signal processor, in response to the data provided by the input device, provides the data to the standard signal control panel utilizing a standard signal.

2. The system of claim 1, wherein the data provided by the input device in the secured communication channel includes a dynamic element.

3. The method of claim 2, wherein the dynamic element is used to ensure that a replay attack cannot be used to gain unauthorized access to an entrance portal.

4. The system of claim 1, wherein the standard signal is chosen from a set consisting of Wiegand signals, Mag Stripe signals, and Bar Code signals.

5. The system of claim 1, wherein the signal processor is co-located with the control panel in the secure area.

6. The system of claim 1, wherein the input device includes a smart card reader.

7. The system of claim 1, wherein the input device includes a PIN pad.

8. The system of claim 1, wherein the input device includes a biometric device.

9. The system of claim 1, further including a host computer coupled to the input device and the standard signal control panel, the host computer communicating parameters to the input device and the standard signal control panel through secured channels.

10. The system of claim 1, wherein the communications channel is secured using at least one of the following methods:
encryption of the transmitted information; and/or
authentication of the transmitted information using a digital signature; and/or
the use of a dynamic element, shared by input device and the signal processor to protect against replay attacks.

11. The system of claim 1, wherein the input device communicates with the signal processor in a self-clocked non return to zero or Di-phase communication.

12. An access system comprising:
means for receiving authentication and/or identification information provided by a user;
means for securely transmitting the authentication and/or identification information provided by the user;
means for receiving the securely transmitted information; and
means for providing the received information to a standard control panel using standard signals; and
means for controlling access to a secured area based on the information received by the standard control panel.

13. The system of claim 12, wherein the authentication and/or identification information provided by a user includes at least one of smart card information, biometric information, or PIN information.

14. The system of claim 12, wherein means for receiving authentication and/or identification information provided by a user further includes means for combining additional dynamic information with the authentication and/or identification information.

15. The method of claim 14, wherein the additional dynamic information is based on temporal information generated contemporaneously with the authentication and/or identification information provided by the user.

16. The system of claim 12, wherein means for securely transmitting the authentication and/or identification information provided by the user further includes means for digitally signing and/or encrypting the information.

17. The system of claim 12, wherein means for receiving the securely transmitted information further includes means for decrypting and/or authenticating the received information.

18. The system of claim 12, wherein means for means for providing the received information to a standard control panel using standard signals further includes means for translating the received information to a format compatible with standard control panel inputs.

19. The method of claim 18, wherein the standard control panel inputs are chosen from chosen from a set consisting of Wiegand signals, Mag Stripe signals, and Bar Code signals.

20. An access method comprising:
receiving authentication and/or identification information provided by a user through an input device;
securely transmitting the authentication and/or identification information provided by the user;
receiving the securely transmitted information;
providing the received information to a standard control panel using standard signals; and
controlling access to a secured area based on the information received by the standard control panel.

21. The method of claim 20, wherein the authentication and/or identification information provided by a user through an input device includes at least one of smart card information, biometric information, or PIN information.

22. The method of claim 20, wherein receiving authentication and/or identification information provided by a user through an input device further includes combining additional dynamic information with the authentication and/or identification information.

23. The method of claim 22, wherein the additional information is generated by the input device.

24. The method of claim 22 wherein the additional dynamic information is based on temporal information generated contemporaneously with the authentication and/or identification information provided by the user.

25. The method of claim 20 wherein securely transmitting the authentication and/or identification information provided by the user further includes digitally signing and/or encrypting the information.

26. The method of claim 25, wherein the digital signing and/or encryption of the information is performed by the input device.

27. The method of claim 20, wherein the steps of receiving the securely transmitted information and providing the received information to a standard control panel using standard signals are performed by a signal processor.

28. The method of claim 20, wherein receiving the securely transmitted information further includes decrypting and/or authenticating the received information.

29. The method of claim 20 wherein providing the received information to a standard control panel using standard signals further includes translating the received information to a format compatible with standard control panel inputs.

30. The method of claim 29, wherein the standard control panel inputs are chosen from chosen from a set consisting of Wiegand signals, Mag Stripe signals, and Bar Code signals.

31. The method of claim 27, wherein the input device communicates with the signal processor using self-clocked non return to zero or Di-phase communication.
